(19) United States
(12) Patent Application Publication
(10) Pub. No.: US 2012/0131977 A1
(43) Pub. Date: May 31, 2012

(54) Shearing Device for Shearing of Bar Stock and Forming Machine with a Shearing Device for Shearing of Bar Stock

(75) Inventors: Andreas Matt, Murg (DE); Raymond Schoenenberger, Rosenau (FR); Patrick Stemmelin, Moernach (FR); Heinz Stutzmann, Basel (CH)

(73) Assignee: HATEBUR UMFORMMASCHINEN AG, Reinach (CH)

(21) Appl. No.: 13/378,022

(22) PCT Filed: Jun. 11, 2010
(86) PCT No.: PCT/CH2010/000151

§ 371 Date: Feb. 13, 2012

(30) Foreign Application Priority Data
Jun. 16, 2009 (CH) 945/09

(51) Int. Cl. B23D 35/00; B23D 15/04; B23P 17/00

(52) U.S. Cl. 72/337; 83/694

(57) ABSTRACT

A forming machine comprises a shearing device for shearing off a section of a bar stock, a forming station for forming the sheared off bar stock section and a transport device for the bar stock. The shearing device has two shearing blades, of which one is movable transverse to the longitudinal extension of the bar stock. The shearing blades each have an assembly block and a shearing insert attached to this. For one of the shearing blades, the shearing insert is made of a heat-resistant, break-proof and thermal shock-resistant hard material and essentially has the form of a cylindrical half-shell. This shearing insert is arranged in a reception recess of the assembly block, which is adapted in shape, and is releasably clamped to the assembly block by means of screwed clamping blocks.

The invention relates to a shearing device for shearing off a section of a bar stock according to the preamble of independent claim 1 and a forming machine with such a shearing device according to the preamble of claim 15.

In the case of forming machines with one or more forming stations, one section of a rod, which is sheared off from a bar stock, is usually fed into the first forming station for forming. The shearing of the rod normally takes place in a separate shearing station using a fixed shearing blade and a shearing blade which is displacable relative to this, which is moved back and forth by a shearing carriage.

The bar stock to be processed in the forming machine is mostly steel. This means that at least the parts of the shearing device responsible for the shearing effect and their shearing blades are made from a high-strength and substantially harder material compared with the usual steel types. In particular in hot forming machines, where the bar stock is preheated to relatively high forging temperatures, the shearing edges of the shearing blades are exposed to a particularly high degree of wear. The shearing blades and their shearing edges in shearing machines, in which the material to be sheared is processed in a supercooled state (for example, cooled with dry ice or liquid nitrogen), are exposed to a likewise high degree of wear.

Different possibilities are known for the design of the fixed shearing blade and the movable shearing blade.

The shearing blades can e.g. be manufactured as a whole from a material of suitable hardness. This has the disadvantage that the shearing blades must be replaced as a whole when their shearing edges are worn. Moreover, the production of such shearing blades is relatively elaborate and accordingly expensive, particularly also because of the material costs.

To reduce the wear of the shearing edges, it is also known to armor the shearing edges of the shearing blades by welding with hard materials. Furthermore shearing blades are known, in which a shearing insert of hard metal is soldered in a base body. Alternatively, a layer of Stellite® (hard alloy based on cobalt-chromium, a registered trademark of Deloro Stellite Holdings Corporation) can be welded on the base body. All these known shearing blades designs, however, have the disadvantage that the shearing blades must be replaced as a whole when their shearing edges are worn.

Shearing blades in which a shearing insert made of Stellite® is directly screwed onto a base body are also already known. This design principle is advantageous insofar as that only the shearing insert must be replaced when its shearing edge or shearing edges are worn. However the resistance to wear of Stellite® is lower compared to more modern heat-resistant, break-proof and thermal shock-resistant hard materials with a (Rockwell) hardness of at least 55 HRC. An example of such a more modern hard material is the material marketed by the company Ceratizit under the name CTE 50.

The design principle known from shearing blades with Stellite® shearing inserts can not be easily applied to such more modern hard materials because the latter are relatively poorly machinable and comparatively brittle. A direct screwing together of a shearing insert made out of such a hard material would lead to breakage of the latter. In addition, only relatively simple body shapes without much dimensional variation can be produced with reasonable effort from such a hard material.

Based on this prior art, the object of the invention is to improve a shearing device of the aforementioned kind, such that on the one hand the tool life (number of possible shearing processes) of the shearing device is increased and on the other hand, a fast and cheap exchange of the parts that wear of the shearing device is achieved. In addition, the constructional prerequisites for a more economical utilisation of a forming machine should be accomplished through the invention.

This problem is solved by the shearing device according to the invention and the forming machine according to the invention, as they are defined in independent claim 1 and in claim 15 respectively. Particularly advantageous modifications and embodiments of the invention will become apparent from the dependent claims.

The term “bar stock” is to be understood in the present context as each material form with pronounced longitudinal extension and any cross-section which is constant over the longitudinal extension. In particular, bars, rods and wires of any measurements fall within this definition. Circular cross-sections are the norm, however the invention is not limited thereto. The term “rod-shaped” is to be understood similarly.

The essence of the invention is as follows: A shearing device has two shearing blades, of which at least one is movable transverse to the longitudinal extension of the bar stock, wherein the shearing blades each have an assembly block and a shearing insert attached to this, which is made of a wear-resistant hard material. For at least one of the shearing blades, the shearing insert is at least partially made of a heat-resistant, thermal shock-resistant hard material and has essentially the shape of a cylindrical half-shell. This shearing insert is arranged in a reception recess of the assembly block, which is adapted in shape, and is detachably clamped to the assembly block by means of screwed clamping blocks. A forming machine comprises such a shearing device, a forming station for forming the bar stock section which is sheared off and a transport device for the bar stock.

Through the use of heat-resistant, thermal shock-resistant hard material, an increased tool live is achieved over conventional solutions. By mounting the shearing insert by means of the clamping blocks, a simple attachment of the shearing insert is guaranteed and the design of the shearing insert can be kept sufficiently simple, so that it can easily be made from the hard material. If the shearing insert is worn, it can be easily rotated by 180°, so that its reverse side can be used for shearing, or can be wholly replaced.

According to a preferred embodiment of the invention, a shearing blade is fixed and the other shearing blade is movably powered. Since the latter is generally much shorter parallel to the longitudinal direction of the bar stock which is to be sheared off than the fixed shearing blade, the attachment of the shearing insert is more problematic in this case. According to an advantageous embodiment of the invention therefore particularly the movable shearing blade is provided with the shearing insert which is clamped by means of clamping blocks. Alternatively, however, also the fixed shearing blade may be provided with the shearing insert which is clamped by means of clamping blocks. Particularly advantageously both shearing blades are made in this regard in a similar manner, i.e. on both the shearing blades the shearing insert is detachably clamped by means of clamping blocks.

Advantageously, the shearing insert is pretensioned with the help of the clamping blocks, which has favorable effects on the fracture strength of the shearing insert.

Suitably, the shearing insert is secured against displacement in an axial direction during the shearing process by a collar which is shaped on the edge of the reception recess. Likewise, it is advantageous to secure the clamping blocks against axial displacement, particularly with a groove/tongue combination.

The shearing insert is made of the hard material either as a whole or at least in the region of its shearing edge. The shearing insert can also be surface-treated, particularly surface-coated.

The hard material preferably has a Rockwell hardness of at least 55 HRC, and according to a preferred embodiment, is heat resistant up to about 1300° C. Most especially preferred, a hard material is used, which withstands quenching using a coolant at room temperature or lower.

Advantageously, the hard material can be a sintered hard metal, preferably of tungsten carbide-cobalt sintered materials, preferably with additives to increase the heat-resistance and thermal shock-resistance. Alternatively, the hard material can also be a non-metallic hard material, e.g. ceramic, with high heat-resistance and thermal shock-resistance.

In the following, the shearing device according to the invention and the forming machine according to the invention are described in more detail by way of an embodiment depicted in the drawings. Shown is:

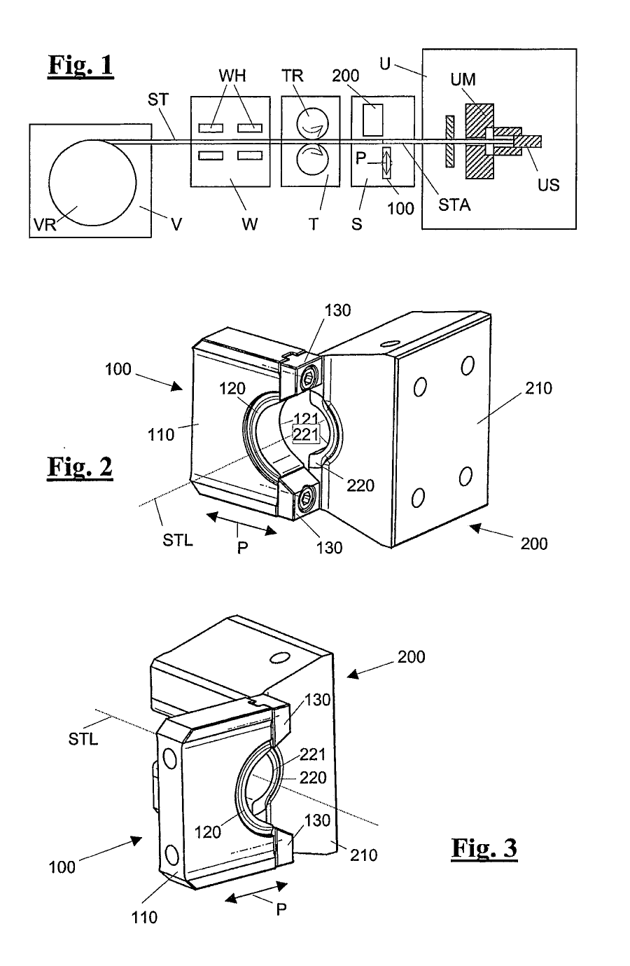

FIG. 1—a schematic representation of the essential parts of an embodiment of the forming machine according to the invention, which is equipped with a shearing device;

FIGS. 2 and 3—two oblique views from different directions of the two shearing blades of the shearing device according to the invention of the forming machine;

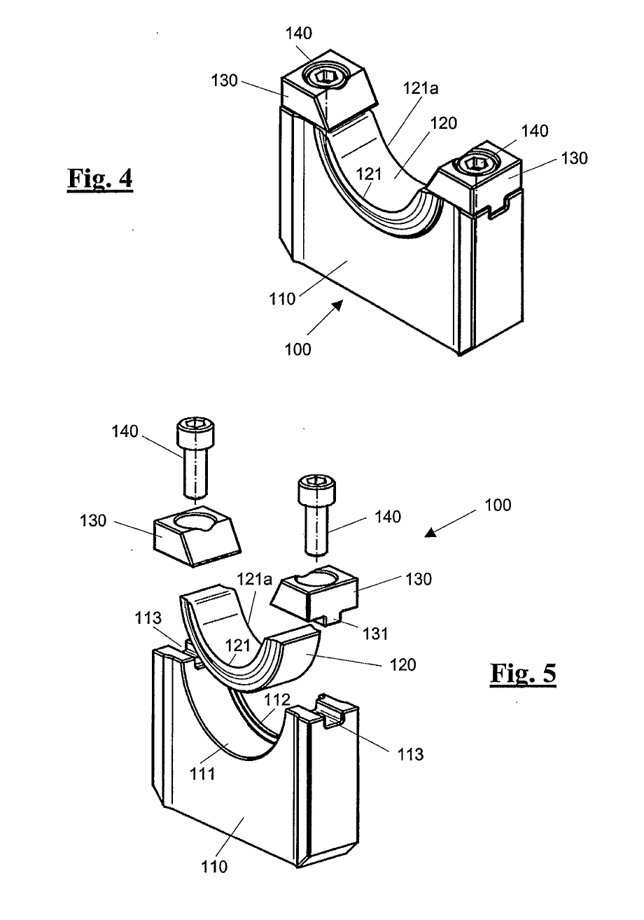

FIG. 4—an oblique view of the movable shearing blade of the shearing device and

FIG. 5—an exploded view of the movable shearing blade of FIG. 4.

The following stipulation applies for the description hereafter: if reference numerals are given in a figure for the purpose of clarity of the drawings, but are not mentioned in the description part which is directly associated with it, then reference is to be made to the explanation in connection with the remaining figures.

The forming machine according to the invention is designed as a hot-forming machine and according to FIG. 1 comprises a storage magazine V for rod-shaped material ST, a preheater W for the bar stock ST, a transport device T for feeding in the bar stock ST, a shearing device S to shear off a section of the bar stock ST and a forming station U for forming the bar stock section STA into a desired shape. Where appropriate, two or more forming stations can be provided, which the bar stock section successively passes through and in which the forming takes place in two or more part stages.

In the storage magazine V the bar stock ST is, for example, wound on a supply roll VR. The preheater W contains one or more heaters WH, which heat up the bar stock to the required operating temperature. The transport device T typically comprises transport rolls TR which are motor-driven. The shearing device S comprises two shearing blades 100 and 200, which are movable relative to each other in a plane transverse to the longitudinal direction of the bar stock ST. Typically, one of the shearing blades 200 is stationarily positioned and the other shearing blade 100 is positioned on a driven carriage, which is not illustrated. The adjustability of the shearing blade 100 is symbolized in FIGS. 1-3 by an arrow P. The forming station U typically comprises a die UM and a punch US.

The invention is not limited to hot-forming machines. In the case of a cold-forming machine, the preheating station W would be omitted. In case the sheared section is not further formed, the forming station U is also omitted.

So far the forming machine according to the invention and the shearing device itself corresponds to the state of the art, as described in detail e.g. in WO 2001/028711 A1 and WO 2006/086901 A1 as well as the documents listed in the associated search reports. The person skilled in the art therefore does not require further explanation in this regard.

The main difference of the forming machine according to the invention to the forming machines of the prior art is in the special design of the shearing device S. This will be described in the following in more detail with reference to FIGS. 2-5.

As already mentioned, the shearing device according to the invention comprises a fixed shearing blade 200 and a movable shearing blade 100, between which in operation the bar stock ST, which is to be sheared, is fed. The latter is indicated in FIGS. 2 and 3 by a dotted and dashed line STL. The movable shearing blade 100 is arranged in a known manner on a driven carriage, which is not illustrated, which is symbolized by the double arrow P. The direction of movement of the shearing blade 100 runs in a plane vertical to the longitudinal extension of the bar stock ST.

The fixed shearing blade 200, which is referred to hereafter as the fixed blade, comprises an assembly block 210 made of tool steel and a shearing insert 220 fixed on it which is made of a particularly hard and wear-resistant hard material, such as a sintered hard metal. The shearing insert 220 has essentially the shape of a cylindrical half-shell and is fixably or detachably connected to the assembly block 210. The fixed blade 200 and its shearing insert 220 are oriented so that the cylinder axis of the latter, which is not shown, runs parallel to the longitudinal extension, which is symbolised by the line STL, of the bar stock ST which is to be sheared. The arc shaped edge 221 between the flat front surface and the cylindrical inner surface of the shearing insert 220 forms the shearing edge of the fixed blade 200 which is used in the shearing process. The front surface of the shearing insert 220 is offset axially slightly inwards radial outside of the shearing edge 221, i.e. the shearing edge 221 protrudes slightly over the rest of the front surface. In addition the front surface and the shearing edge 221 of the shearing insert 220 also project over the assembly block 210. In this way, friction with the bar stock to be sheared is avoided in operation.

The heat-resistant, break-proof and thermal shock-resistant hard material preferably has a Rockwell hardness of at least 55 HRC, and in accordance with a preferred embodiment, is heat resistant up to about 1300° C. Most preferably a hard material is used, which withstands quenching using a coolant at room temperature or lower.

Advantageously, the hard material can be a sintered hard metal, preferably of tungsten carbide-cobalt sintered materials, preferably with additives to increase the heat resistance and thermal shock resistance.

The hard material can also be a non-metallic hard material, e.g. ceramic, with high heat resistance and thermal shock resistance.

A suitable hard material is e.g. the material CTE 50 marketed by the company Ceratizit.

The shearing insert is made from the hard material either as a whole or at least in the region of its shearing edge. The shearing insert can also be surface-treated, in particular surface-coated.

The movable shearing blade 100, which is referred to hereafter as the flat blade, comprises an assembly block 110 made of tool steel, which in comparison to the assembly block 210 of the fixed blade 200 is narrower, and a shearing insert 120 detachably secured to it, made from said hard material. The shearing insert 120 has essentially the form of a cylindrical half-shell, like the shearing insert 220 of the fixed blade. The flat blade 100 and its shearing insert 120 are oriented so that the cylinder axis of the latter, which is not illustrated, runs parallel to the longitudinal extension, which is symbolized by the line STL, of the bar stock ST to be sheared. The arc-shaped edge 121 between the flat front surface and the cylindrical inner surface of the shearing insert 120 forms the shearing edge of the flat blade 200, which is used for the shearing process. The front surface of the shearing insert 120 is offset axially slightly inwards radial outside of the shearing edge 121, i.e. the shearing edge 121 protrudes slightly over the rest of the front surface. In addition the front surface and the shearing edge 121 of the shearing insert 120 also project over the assembly block 110. In this way, friction with the bar stock to be sheared is avoided in operation.

The arc-shaped shearing edges 121 and 221 of the flat blade 100 and of the fixed blade 200 lie axially close to each other in planes perpendicular to the longitudinal extension of the bar stock which is to be sheared, wherein the axial distance between the two shearing edges is sufficiently large that the two shearing inserts 121 and 221 do not touch with the movement of the flat blade.

FIGS. 4 and 5 show the structure of the flat blade 100 in detail. The assembly block 110 has a cylindrical reception recess 111, which is adapted to the shape of the outer cylindrical surface of the shearing insert 120, in which the shearing insert 120 is placed. The reception recess 111 is provided with a collar 112 on the side away from the fixed blade 200, against which the shearing insert 120 is axially supported, so that it can not move axially during the shearing process. The shearing insert 120 has the relatively simple form of a cylindrical half-shell, which is easily made out of the hard material, e.g. sintered hard metal. The shearing insert 120 is secured by means of two clamping blocks 130 in the reception recess 111. The clamping blocks 130 are each screwed together with the assembly block 110 by a screw 140. Clamping blocks and screws are made of tool steel. The assembly block 110 is provided on both sides of the reception recess 111 with a groove 113, in which each a tongue 131 is engaged, designed diametrically opposed on the clamping blocks 130. This groove/tongue combination secures the clamping blocks 130 against movement in direction of the axis of the shearing insert 120. According to the axial dimension of the shearing insert 120, two or more screws can also be provided for mounting each of the clamping blocks 130. By the shearing insert 120 protruding slightly toward the clamping blocks beyond the contour of the assembly block 110, a certain pretensioning of the shearing insert 120 can be generated by the clamping blocks 130 which are screwed, so that its fracture strength is increased. By the mounting of the shearing insert 120 by means of the clamping blocks 130, a simple fastening of the shearing insert is achieved and the shape of the shearing insert can be kept simple, so that it can easily be made from the hard material and so that it has no unnecessary edges and transitions, which would heighten the risk of fracture under stress.

The detachable mounting of the shearing insert 120 in the assembly block 110 of the flat blade 100 has the advantage that after the service life, when the shearing insert is worn, only the shearing insert 120 itself needs to be exchanged, but not the entire shearing blade. Moreover, the shearing insert 120 can be rotated 180° (in a conventional manner), so that its rear edge 121a, which is arc-shaped, becomes the active shearing edge. In this way, the useful lifetime of the shearing blade is doubled with minimal effort.

In the above-described embodiment of the shearing device of the invention, only the movable flat blade 100 is designed with a mounted shearing insert 120, while the stationary fixed blade 200 is formed conventionally or the attachment of the shearing insert is solved in a different way. The reverse arrangement is however also possible. In the case of the flat blade 100, the mounting according to the invention of the shearing insert by means of the clamping blocks is particularly important, because insufficient space would be available there for another attachment of the shearing insert. More options are available for the relatively larger fixed blade for mounting of the shearing insert. Especially advantageous is to design both shearing blades in a similar manner with a mounted shearing insert made of hard material.

1. A shearing device for shearing off a section of a bar stock comprising two shearing blades, of which at least one is movably transverse to the longitudinal extension of the bar stock, wherein the shearing blades each have an assembly block and a shearing insert attached to this, which is made of a wear-resistant hard material, wherein for at least one of the shearing blades, the shearing insert is at least partially made of a heat-resistant, thermal shock-resistant hard material and has essentially the form of a cylindrical half-shell, and wherein this shearing insert is arranged in a reception recess of the assembly block, which is adapted in shape, and is detachably clamped to the assembly block by means of screwed clamping blocks.

2. The shearing device according to claim 1, wherein the shearing insert slightly protrudes from the reception recess and is pretensioned by the clamping blocks.

3. The shearing device according to claim 1, wherein the reception recess of the assembly block has a collar, which secures the shearing insert against displacement in an axial direction.

4. The shearing device according to claim 1, wherein the clamping blocks are secured against displacement in the axial direction of the shearing insert, in particular by a groove/tongue combination.

5. The shearing device according to claim 1, wherein the shearing blade provided with the shearing insert, which is mounted by means of clamping blocks, is the shearing blade which is movably.

6. The shearing device according to claim 1, wherein the shearing blade provided with the shearing insert, which is mounted by means of clamping blocks, is fixed in position.

7. The shearing device according to claim 1, wherein for the two shearing blades, the shearing inserts, are at least partially made of a heat-resistant, thermal shock-resistant hard material and essentially have the shape of a cylindrical half-shell and that the shearing inserts for both shearing blades are detachably clamped by means of clamping blocks on the assembly blocks.

8. The shearing device according to claim 1, wherein the hard material has a Rockwell hardness of at least 55 HRC.

9. The shearing device according to claim 1, wherein the hard material has a temperature resistance up to at least about 1300° C.

10. The shearing device according to claim 1, wherein the hard material withstands a quenching process with a coolant at room temperature or colder.

11. The shearing device according to claim 1, wherein the hard material is a sintered hard metal.

12. The shearing device according to claim 1, wherein the hard material is a non-metallic hard material, preferably ceramic.

13. The shearing device according to claim 1, wherein the shearing insert or shearing inserts, is or are made of the hard material at least in the region of the cutting edge.

14. The shearing device according to claim 1, wherein the shearing insert or shearing inserts is or are surface-treated, in particular surface-coated.

15. A forming machine with a shearing device to shear off a section of a bar stock, with at least one forming station for forming the sheared off bar stock section and with a transport device for the bar stock, wherein the shearing device is designed according to claim 1.
